(19) United States
(12) Patent Application Publication
(10) Pub. No.: US 2026/0118225 A1
(43) Pub. Date: Apr. 30, 2026

(54) MULTIMODAL SYSTEM AND METHOD FOR REAL-TIME POSITIONING OF SENSORS FOR MACHINE DIAGNOSTICS

(71) Applicant: BOLTX AI LTD, Haifa (IL)

(72) Inventor: Ori Negri, Haifa (IL)

(21) Appl. No.: 19/374,589

(22) Filed: Oct. 30, 2025

Related U.S. Application Data
(60) Provisional application No. 63/714,403, filed on Oct. 31, 2024.
(60) Provisional application No. 63/792,948, filed on Apr. 23, 2025.

(51) Int. Cl. G01M 99/00

(52) U.S. Cl. CPC G01M 99/005

(57) ABSTRACT

A system and method are disclosed for advanced multimodal-sensor systems integrating various sensing characteristics for machine condition monitoring, including thermal imaging cameras, ultrasonic, vibration, temperature, magnetic sensors, high-band microphones, electro-magnetic emission detectors and others. The system's architecture comprises edge computing capabilities for real-time anomaly detection and operational feedback, utilizing edge machine learning (ML) models trained in the cloud. The system supports flexible configuration and calibration to optimize measurements based on machine requirements, while a cloud-based analysis framework enables robust data fusion, training and condition assessment. The method comprises performing automated diagnostic workflows enabled by models at the edge, reducing or eliminating human intervention, and significantly enhancing operational performance, maintenance and efficiency across multiple machines in an industrial setting.

### CROSS-REFERENCE TO RELATED APPLICATION(S)

This application claims priority to US Provisional application filed on Oct. 31, 2024 having application No. 63/714,403 and US Provisional application filed on Apr. 23, 2025 having application No. 63/792,948, which are both incorporated by reference hereto in their entirety.

### FIELD

The present disclosure relates to industrial equipment condition monitoring using real time adaptive sensor positioning with trained machine learning (ML) models to identify performance, efficiency and preventative maintenance measures in natural language instructions to autonomous mobile platforms or operators.

### BACKGROUND

Globally, there is a critical need for skilled operators to monitor the millions of industrial machines requiring routine and predictive performance, efficiency and maintenance measures. For example, training a competent vibration analyst takes many years of experience. With industrial expansion outpacing technician training, facilities routinely operate with maintenance deficits, and they are not operating at their peak performance and efficiency. https://www.weforum.org/stories/2025/04/indiana-college-manufacturing-talent-skills-gap/

Today, existing diagnostic systems use fixed sensors with limited modalities that capture only fragments of machine condition information. These fixed sensors are constrained by installation costs, power limitations, and inability to adaptively reposition sensors on or near the industrial machine as conditions change in real-time. In addition, current diagnostic systems lack adaptive intelligence to modify their measurement strategies real-time based on emerging conditions. They collect data passively rather than actively and do not investigate developing faults by changing the spatial positioning of the sensors, temporal measurement strategy and the sensor modalities.

For example, while U.S. Pat. No. 11,934,184 ('184) discloses a diagnostic system that uses static sensors to monitor machines, it lacks the ability: 1) to perform spatial modeling of the machine with sensors, 2) to adaptively move the sensors to new locations, and 3) to change the one or more of the sensor's modalities in real time on/at or near the machine to perform further monitoring. The diagnostic systems disclosed in the '184 patent have limited “diagnostic resolution” of the machine due to limitations of having static sensors with limited modalities and data structures that do not scale efficiently to accommodate millions of data points for model training and inference over different locations and modalities.

The above information disclosed in this Background section is only for enhancement of understanding of the present disclosure, and therefore it may contain information that does not form the prior art that is already known to a person of ordinary skill in the art.

### SUMMARY

There is a need for systems having significantly higher spatial and temporal resolution to assess machine health more accurately and efficiently using a plurality of non-static sensors, capable of multiple modalities and in different locations that can produce millions of data points that can be efficiently represented, compared and used in models to determine machine health.

The embodiments of the present disclosure overcome the limitations of the prior diagnostic systems with an autonomous adaptive sensing system that uses three degrees of freedom in sensing: spatial, temporal, and multiple modalities. The system enables dynamic and real time adaptation of i) measurement parameters to optimize the sensor's location on the machine, ii) the rate of measurement and sampling configurations (sampling frequency, duration, gain, etc.), and iii) sensor types (for example, acoustic, RF, vibration, magnetic, temperature, visual, etc.) needed for analysis of machine condition, accurate fault detection and remedial measures. In some embodiments, the adaptations are made in real time using specially-trained machine learning (ML) models. The system outputs natural language instructions for operators (e.g., technicians) to follow or for autonomous mobile units (e.g., robots) to carry out.

The present disclosure provides for an adaptive positioning system of a plurality of sensors monitoring a machine's condition within an industrial setting, each sensor having one or more modalities for monitoring one or more conditions of the machine, each sensor obtaining raw data along with location information for the sensor and metadata for identifying the machine. The adaptive system encodes the raw data to align the data (e.g., spatially and temporally) into matrix data and to fuse the data for encodings representative of the machine's condition (e.g., using a neural network), trains a first model stored in non-volatile memory with the machine's baseline-condition history, prompts the first model to detect anomalies in the encoded raw data compared to the machine's baseline-condition history, wherein the characteristics of the machine anomaly can be determined, trains a second model stored in non-volatile memory with the machine's images and internal structures, and prompts the second model to automatically map out a strategy for adaptive positioning of one or more of the plurality of sensors to one or more locations of the machine to detect machine anomalies. In some embodiments of the present disclosure, the adaptive positioning system maps out the strategy to further detect, diagnose, rule out or remediate the machine anomalies.

In some embodiments of the present disclosure, the sensor positioning system is transported by an autonomous mobile platform such as a robot or a drone, or any other autonomous mobile system that can change the sensor's location on the machine and/or industrial floor, without human intervention. For example, a quadruped robot could be instructed by the adaptive systems ML model(s) located at the robot to place one or more chosen sensors at a specific location on or near the machine where sensitivity and signal quality is best for finding the underlying condition of the machine.

The adaptive system may incorporate a comprehensive package of sensors including, but not limited to, vibration, magnetic, acoustic, temperature, electromagnetic (e.g., radio frequency (RF)), CO₂, humidity sensors, and visual sensors (e.g., visible light and invisible light (e.g., infrared) cameras and computer vision processing applied to images captured by the cameras). These sensors can be deployed as a single unit or multiple units to any machine. Various attachment and detachment mechanisms using electromagnetic and mechanical systems enable the operator or the autonomous mobile platform to precisely place and secure the sensing unit, then retrieve it for repositioning, so that vibration for example at high frequency can be mediated with minimal loss from the machine to the sensor. A ML accelerator (e.g., a neural net processor) using a unique pre-trained ML model determines optimal measurement positions and strategies, and processes multi-modal data for enhanced fault detection. Natural language instructions are provided to operators or autonomous mobile platforms to carry out these instructions. With respect to autonomous mobile platforms, this approach operates continuously without fatigue or scheduling constraints, helping to substantially eliminate human error and inconsistency while maintaining exact repeatability of monitoring positions. The system safely accesses and navigates dangerous locations on industrial floors and equipment, performs consistent monitoring around the clock, and scales monitoring frequency and accuracy. It adapts the sensors to locations and positions based on machine condition and emerging fault signatures, deploying the full range of sensor modalities to any location without constraints. The system supports high-powered, high-sensitivity sensors without energy limitations while enabling flexibility in spatial positioning, measurement timing, and/or sensor modality selection.

With respect to the embodiments of the disclosure where an operator obtains natural language instructions from the system, the operator can be an unskilled factory worker, guided by a simple interface on a tablet. Such instructions could be for example of the form: “Place sensor(s) here. Press start. Now move the sensor here.” On the other hand, an autonomous robot is, in essence, a perfectly consistent and tireless unskilled operator. It does not need to understand why it is placing a sensor at a specific location; it only needs to execute the instructions to “move to coordinate (x,y,z).” By translating the diagnostic signature into direct motion and action instructions for the robot, the system achieves accuracy, consistency, repeatability, and safety. The robot can perform monitoring 24/7, in hazardous conditions and areas, and at identical locations with micron-level movements and exacting precision every time.

In other embodiments of the present disclosure the adaptive sensing system employs a hierarchical deep learning architecture with multiple specialized neural networks combined and trained simultaneously (or concurrently) to benefit from the cross correlation of sensing modalities and measurements. Deep neural networks such as convolutional neural networks process raw sensor data, automatically learning relevant features without manual engineering. Separate networks specialize in time-domain, frequency-domain, and time-frequency representations. Transformer networks with attention mechanisms identify relationships between different sensor locations and modalities, discovering patterns invisible when analyzing static sensors independently. Then multi temporal networks analyze how fault signatures evolve over time, learning the progression patterns of different failure modes using an ensemble of anomaly classifiers to combine predictions through learned weighting schemes.

The other embodiments of the disclosure, autonomous mobile platforms may be deployed such as humanoids, quadruped robots or “robot dogs” with an integrated robotic arm(s) that holds the sensing units using a mechanical adapter attachment or in the case of a humanoid that can hold the sensing unit in its arm with or without an adapter. The robotic platform incorporates systems that enable autonomous operation in complex industrial settings using computer vision and/or LiDAR mapping of industrial spaces. Using a dedicated computer vision system provides measurement points and calibrates it using sensor feedback for precision. The system maintains position memory for repeated measurements at identical locations, ensuring consistency across time. Measurement sequences are optimized based on equipment criticality and operational schedules. For larger facilities that system can employ multiple platforms to operate simultaneously.

### BRIEF DESCRIPTION OF THE DRAWINGS

The accompanying drawings, together with the specification, illustrate exemplary embodiments of the present invention, and, together with the description, serve to explain the principles of the present invention.

FIG. 1A is a schematic diagram of one exemplary embodiment of a diagnostic system of the present disclosure.

FIG. 1B provides additional information and exemplary details about the sensors of a diagnostic system, according to one embodiment of the present disclosure.

FIG. 2 provides a flow diagram of the process followed by a diagnostic system according to one embodiment of the present disclosure.

FIG. 3 provides a high-level work flow pictorial version of the flow diagram provided in FIG. 2, according to one embodiment of the present disclosure.

FIG. 4 provides a high-level single machine diagnostic workflow, according to one embodiment of the present disclosure.

FIG. 5 provides the work flow diagram for providing diagnostics to an entire industrial facility of machines, according to one embodiment of the present disclosure.

FIG. 6 is a table providing the details of each sensor modality and the information provided in the 2D matrix output of spatial and temporal information, according to one embodiment of the present disclosure.

FIG. 7 provides example matrices for four of the sensors referenced in FIG. 6, according to one embodiment of the present disclosure.

FIG. 8 illustrates an attachment and detachment mechanism for a robot to securely and precisely place and retrieve a sensing unit on a machine for measurement, according to one embodiment of the present disclosure.

FIG. 9 is an exploded view of an exemplary sensing unit, according to one embodiment of the present disclosure.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein.

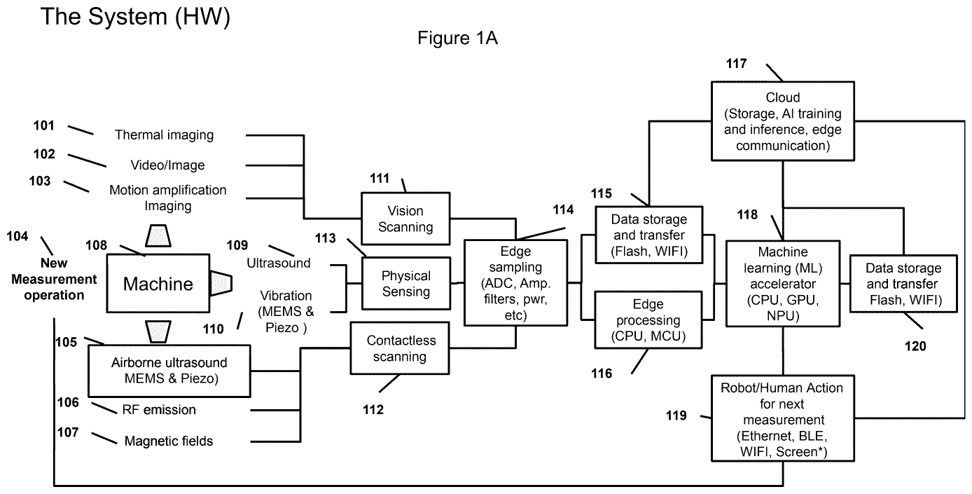

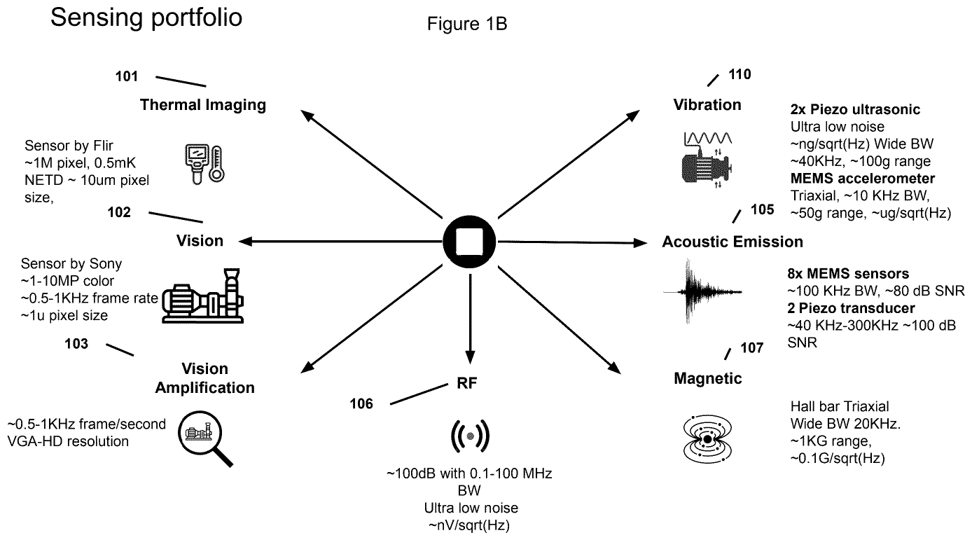

FIG. 1A is a schematic diagram of one exemplary embodiment of the diagnostic system 101 of the present disclosure and FIG. 1B provides additional information and exemplary details about the sensors. A comprehensive array including but not limited to vibration (piezoelectric and microelectromechanical systems (MEMS)), magnetic field, acoustic emission, ultrasonic, thermal imaging, radio frequency (RF) electromagnetic emission, and environmental sensors is shown providing observability of the health of a machine (e.g., an industrial machine such as AC motors, DC motors, pumps, compressors, fans, chillers, gear boxes, etc.) across physical domains.

In the exemplary embodiment, thermal imaging sensor 101 is one or more high-resolution infrared cameras that create thermal maps revealing hot spots from, for example, friction, electrical resistance, or flow restrictions. Vision sensor (video/images) 102 and motion amplification sensors 103 are standard and high-frame-rate cameras that enable visual inspection (video and images) that can be used for techniques like Euler magnification to visualize subtle vibrations of revolution per minute (RPM) harmonics or other relevant frequencies. This vision sensor 102 provides evidence of faults and by way of example assists in differentiating between structural faults detected by the vibration sensor 110, like misalignment, unbalance or looseness. Ultrasound sensor 109 and airborne ultrasound sensor 105 are an array of wideband ultrasonic microphones plus dual piezoelectric ultrasonic resonance transducers. This exemplary configuration detects incipient failures through stress wave emissions, identifying issues like electrical arcing, gas leaks, and high-frequency sounds associated with bearing wear.

The vibration sensor 110 (e.g., multi-vibration sensing data) in this exemplary embodiment combines piezoelectric accelerometers with MEMS accelerometers. This dual approach overcomes the traditional trade-off between low-frequency trending and high-frequency fault detection. MEMS sensors show significantly lower 1/f noise floor at lower frequencies (a couple of Hz), have a stable temperature dependence, but at higher frequencies have higher noise and are limited in their bandwidth. Piezoelectric accelerometers on the other hand have higher 1/f noise which drop sharply above 10 Hz to yield an order of magnitude lower noise floor than MEMS. They have much higher bandwidth which support ultrasonic acceleration detection above 20 KHz (which is highly important for early signs of bearing defect).

Radio frequency (RF) emission sensor 106 or electromagnetic wave or emission sensor in this exemplary embodiment provides for wideband (e.g. RF band between sub MHz to dozens of MHz) detection of electromagnetic emissions from, for example, electrical arcing, partial discharge, or corona effects in high-voltage equipment. This capability identifies insulation breakdown in motors or transformers, electrical drivers months before failure. In some embodiments, an RF emission sensor 106 is implemented using one or more antennas (e.g., a single antenna or an antenna array) and an amplifier circuit.

Magnetic field sensor 107 in this exemplary embodiment are tri-axial Hall effect sensors, where the magnetic field sensor detects electromagnetic signatures from electrical machines. This provides an operational parameter of machines (by detecting the line frequency (LF) of the drive and the slip in induction motor) which is correlated to the load. Some embodiments use magnetic field sensors to identify magnetic emissions generated by electrical faults such as rotor bar cracks through sidebands in the magnetic spectrum, stator winding shorts via harmonic analysis, and air gap eccentricity through flux variations—faults that would be invisible to vibration monitoring alone.

The sensors can be described as either contact or non-contact sensors. The non-contact (or contactless) sensors perform sensing without physical contact with the machine 108 (e.g. airborne ultrasound 105, RF emission 106, magnetic fields 107), thermal 101) and vision 102) and the contact sensors (e.g. ultrasound 109 and multi-modal vibration 110 combining analog piezoelectric and MEMS vibration sensing technology) physically contact or touch the machine 108.

With reference to FIG. 1A, the system supports flexible configuration and parameter tuning of the sensor arrays to adapt or optimize the measurements based on the machine requirement being monitored. Vision scanning system 111 receives signals and controls parameters of the thermal imaging sensors 101, video/image sensors 102 and motion amplification imaging sensors 103, physical sensing system 113 receives signals and controls parameters of the ultrasound sensors 109 and multi-modal vibration sensors 110, and contactless sensing system 112 receives signals and controls parameters of the airborne ultrasound sensors 105, RF emission sensors 106 and magnetic field sensors 107. Vision scanning system 111, physical sensing system 112 and contactless scanning system 113 provide raw data signals to the edge sampling component 114 to perform analog-to-digital (ADC) sampling (as appropriate for the underlying sensors and type of sensor data, such as one-dimensional versus two-dimensional data and data that is collected over a sampling window or sampling period), amplification, filtering, and/or normalization to ensure measurement consistency and quality (e.g., the edge sampling component may be implemented using a digital signal processor (DSP) or the like). The edge processor 116 may be implemented using a central processing unit (CPU) (e.g., Arm® Cortex® A55), within a system-on-chip (SoC) (e.g., NXP® IMX 95), or microcontroller unit (MCU) (e.g., STMicroelectronics® STM32®) 116, or the like. This raw data is also stored at storage and transfer 115 (e.g., non-volatile memory such as flash memory and a communication link such as a WiFi network adapter) and then transferred to the cloud 117 (e.g., a server computer system located on a local network or in a remote location such as a remote data center that may be provided by a cloud computing service) for long term storage.

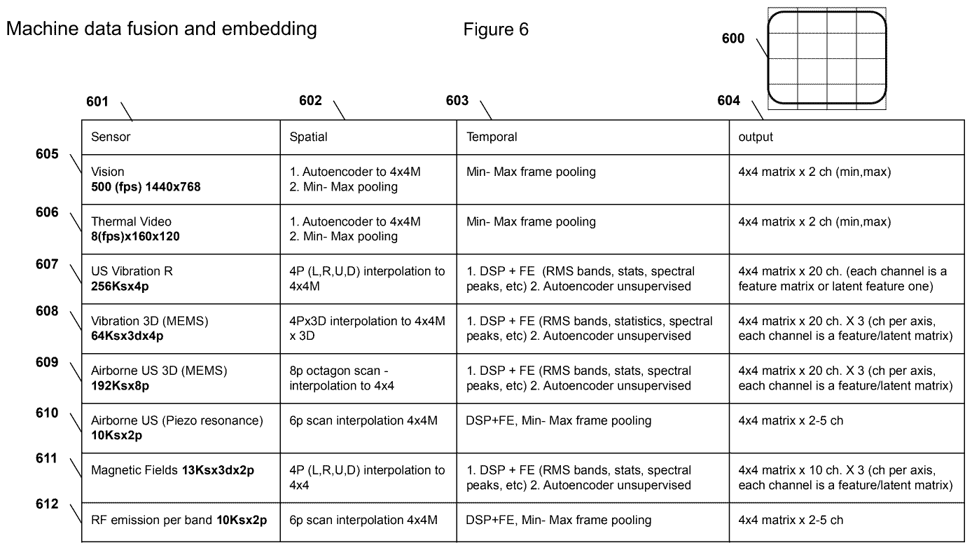

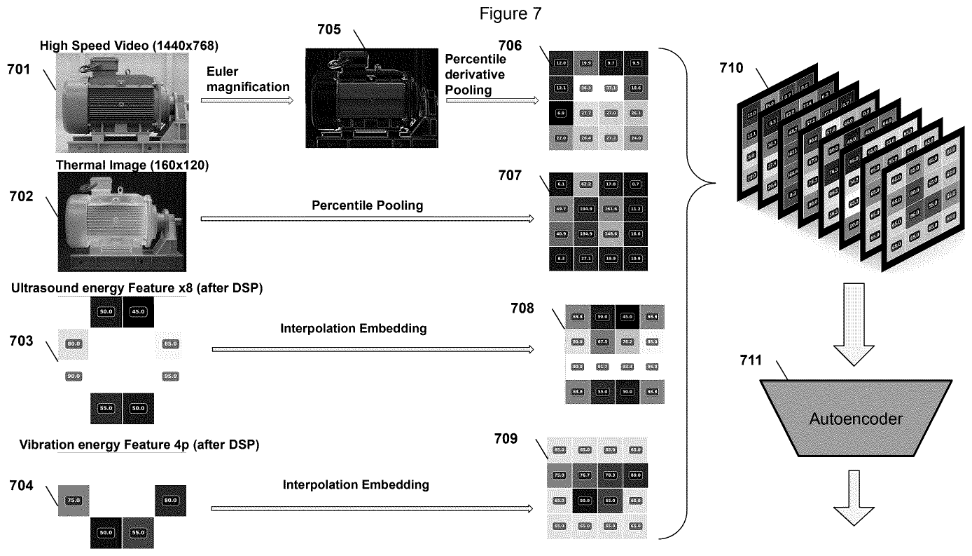

Edge processor 116 also extracts features from the raw data by applying various steps using digital signal processing, fast Fourier transforms, neural nets encoding etc. to obtain, for example, statistical features such as root mean square (RMS) values calculated over various frequency bands, spectral peaks, stats, Min/Max frame pools, etc. which are stored in the history database, total energy features of multi-modal sensors in latent space. As will be described in more detail below with respect to block 203, the extracted features may be single-modal features (e.g., features extracted from a single sensing modality) and multi-modal features (e.g., features extracted from a combination of two or more sensing modalities). Machine learning (ML) accelerator 118 (in this embodiment located at the edge, e.g., physically near or local to the sensors) may be used to extract various features and also to perform fusion of the raw data into matrices by performing spatial and temporal correlation of the data explained in more detail with reference FIGS. 6 and 7. In some embodiments, this fusion step is performed in cloud 117. The data is fused by obtaining the raw data measurements at a particular timestamp/period, spatial location and machine. These matrices are then fed into ML models (running in the cloud or locally on a processor at the edge) to autoencode the data and to extract features. The ML models for example include convolutional and transformers neural networks, and signal processing including Fourier transforms, spectral peak extraction to extract key features and reduce dimensionality. The ML accelerator 118 may be a special-purpose processor for accelerating computations associated with machine learning (e.g., performing inference and training on neural networks), such as for performing vector/matrix operations, implementing neural network activation functions (e.g., SoftMax), and the like In some examples, the ML accelerator 118 is implemented using a Hailo®-8 M.2 AI acceleration module capable of 26 trillion operations/sec., enabling graphics processing unit (GPU) level operations at the edge or another suitable GPU (see, e.g., https://hailo.ai/products/ai-accelerators/hailo-8-m2-ai-acceleration-module/), although embodiments of the present disclosure are not limited thereto and may be implemented using other ML accelerator hardware such as an edge neural processing unit (NPU). The ML accelerator 118 runs, in this example, a lightweight ML model that was previously trained (e.g., in the cloud 117) and deployed at edge (e.g., local to the sensors and the machine 108). The role of the ML accelerator processor 118 can change with less or more computational capacity. For example, retraining (fine tuning), fusion and/or anomaly detection can be performed in the cloud 117 or at the edge (e.g., using the ML accelerator 118), depending on the computational performance capabilities of these systems, and the communication efficiency and availability to and from the cloud 117. For example, the ML accelerator processor 118 at the edge could run offline when there is no connectivity and perform these tasks in embodiments where the ML accelerator 118 has enough computational capacity (e.g., to complete the retraining or fine tuning before the system is expected to be online again and/or where performing the retraining on the ML accelerator 118 is more efficient or cost effective than moving the training data and the model for retraining or fine tuning to the cloud 117).

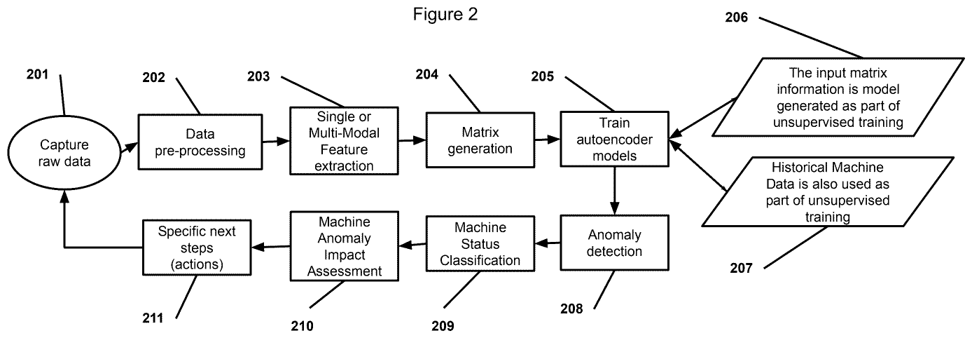

All of the processed data and inference outputs for anomaly detection are stored in data storage unit 120 for maintaining a history repository for further analysis and ML model training. Once the anomaly detection is performed at either ML accelerator 118 and/or in the cloud 117, the anomaly data is provided to another pretrained model or neural network (using digital signal processing) at the cloud or edge and, in response, generates natural language instructions that are provided to an autonomous mobile platform or a human 119 to take additional targeted measurements (e.g. over different periods of time or a different sample frequencies or both) for further diagnostic analysis (e.g. optimizing sampling and/or taking measurements at one more other locations) or take various actions including steps for maintenance or tuning machine parameters for optimal performance or efficiency. By using a multi-temporal approach, some embodiments of the present disclosure track how fault signatures evolve over time, learning the progression patterns of different failure modes using anomaly classifiers to combine predictions through learned weighting schemes. Then model inference generates the actions to be performed including steps for maintenance or tuning machine parameters for optimal performance or efficiency. Further details on these steps can be found with reference to FIG. 2.

FIG. 2 provides a flow diagram of the process followed by the diagnostic system of FIG. 1A. At block 201 raw data is captured from multiple (e.g., all) sensor modalities (such as the modalities shown in FIG. 1B) with time alignment across multiple locations of a machine. Then at block 202 data pre-processing occurs providing, for example, filtering, averaging, interpolation between points, signal to noise improvements, normalization etc. to ensure measurement consistency and data quality.

At block 203 various steps are taken to extract single and/or multi-modal features including such as RMS bands, spectral peaks, stats, Min/Max frame pools, etc. which are stored in the history database. These steps may apply for example digital signal processing (DSP), Fast Fourier Transform (FFT), Neural Net feature Extractor, AutoEncoder, etc. to extract the features or latent features. The feature extraction steps may be applied to raw data received from individual sensors to extract single-modal features (e.g., based on statistics of the raw data as noted above).

In some embodiments, data collected from multiple different sensing modalities may be combined to generate multi-modal features. Table 1, below, provides non-limiting examples of multi-modal features:

TABLE 1

| Feature | Description |
|---|---|
| Aggregate energy | Total Energy of all sensor modalities projected |
| | into a common latent space. Total Energy per |
| | frequency bands |
| Cross-spectral | Entropy of the vibration-acoustic joint |
| entropy | frequency distribution. Entropy per frequency |
| | bands |
| Latent variance of | Variance of multi modal vibration-acoustic- |
| vibration clusters | ultrasound distribution. |
| Transient resonance | Coherence between vibration transients and |
| mapping | fast-imaging features (capturing surface |
| | oscillations). |
| Thermo-mechanical | Covariance of temperature gradients across |
| coupling index | machine normalized to vibration- acoustic |
| | energy |
| Thermo-electrical | Covariance of temperature gradients across |
| coupling index | machine normalized to magnetic-RF energy |
| Cross-modal drift | Temporal gradient of temperature normalized |
| factor | to the temporal variance of magnetic and RF |
| | fields. |
| Latent thermal | Principal component analysis (PCA) variance |
| stability | in a shared latent space of temperature, |
| | vibration, magnetic, RF, and acoustic data |
| | during steady-state operation. |
| Electro-mechanical | Latent energy shared between magnetic and |
| distortion energy | RF harmonics normalized to vibration and |
| | acoustic operational frequency modes. |

In some embodiments, the single or multi-modal feature extraction block 203 performs sensor fusion. Sensor data fusion is the collection of measurement data from multiple types of sensors—such as temperature, pressure, vibration, RF, magnetic, ultrasound, electrical current, and visual sensors—and combining this information at a processing layer (e.g., in block 203) to create a unified and reliable interpretation of equipment conditions. This process improves accuracy and measurement reliability by finding hidden correlations between different sensor modalities, merging redundant or complementary details, using signal processing to extract relevant features and to normalize the data so that outcomes are more robust than those from individual sensors alone.

During the next block 204 2D spatial and temporal matrices are created representative of the extracted features as well as based on other dimensions depending on the modality (e.g., per axis, color, etc.) and then stored back into the history database. At block 205 the models are trained with the spatial/temporal matrices obtained from the history database and input into, for example, 2D convolutional neural network (CNN) and 2D transformer autoencoder models for data fusing and autoencoding. Block 206 provides previously created input matrix information as part of unsupervised training of a separate ML model for each monitored machine and, in some embodiments, for a shared ML model for a machine type. For example, an industrial setting may include multiple pumps that share the same design and specifications. A shared ML model may be trained for the shared underlying pump design, and individual separate models are trained for each individual pump based on the data collected therefrom (e.g., trained from scratch or trained with the shared ML model for the pump type as a starting point). As such, the separate, per-pump ML models capture the individual variation between machines (e.g., where the pumps may operate with different levels of vibration or at different frequencies due to variations in the pumps). At block 207, historical machine data stored in the history database are also used as part of the unsupervised training of the ML models. The trained ML models with attention mechanisms identify relationships between different sensor locations and modalities, discovering patterns invisible when analyzing static sensors independently. The ML models contain data for each machine and for each sensor location and modality measured on the machine.

Anomaly detection occurs at block 208. During this block, the system uses data from the history database accumulated over time with machine encoded data created by the 2D autoencoder ML models to establish a baseline and compares that against newly input encoded data created by 2D autoencoder models for multi-class spatial anomaly detection. At block 209, machine status is computed based on the anomaly detected and the multi-modal autoencoded features. In some embodiments, this model for determining machine status includes a large language model (LLM) and is trained on machine information, machine multi-modal matrix data data encoded by autoencoder, figures stored in the LLM, digital signal processing (DSP) expertise, predictive maintenance (PDM) guidelines, machine diagnosis guidelines (e.g., procedures for vibration analysis) and/or collected data labeled by human experts to classify the machine status. The machine status ML model compares anomalies detected to the baseline of the machine to determine the machine status and determine a confidence level that an identified fault may be/is occurring. For example, in some embodiments, the ML model includes signatures of faults that occur over time and use this information to determine that a fault could occur or is occurring.

At block 210, if a fault is determined at 209, the severity level and impact of the fault is determined. Again, the model for impact assessment is trained on machine information and/or figures stored in LLMs, DSP expertise, PDM guidelines, machine diagnosis guidelines (e.g., procedures for vibration analysis) and/or collected data labeled by human experts to determine the anomaly machine impact.

Then during block 211, the model outputs a specific set of required tasks for additional sensor analysis such as additional sensor measurements (with changes in machine location, machine operation rates (e.g. time-domain, frequency-domain, and time-frequency representation, sensor modes, for example)) for further anomaly analysis as well as follow-on measurement schedules or tuning measures to improve performance or efficiency. This model is trained on images (e.g., photographs) of the machine as well internal structures (e.g., internal schematics) so that mapping instructions to potentially sensitive locations of the machine to detect machine health and failures can occur efficiently. For example, in some embodiments, prior knowledge regarding the machine and/or information from guides (e.g., textbooks, best practices regarding machine diagnosis, etc.) directs the determination (e.g., using a large language model). For example, because a machine is generally a rigid structure, data collected at one location (at a point in time or over a period of time) can be influenced by faults at other locations. For example, if an electrical fault signature appears in vibration data at one location and a thermal image confirms the electrical fault at that location, information about the structure of the machine (e.g., the routing of the wiring) can determine where and how to take the next measurements using vibration sensors and other sensors. As another example, detecting a weak signal (e.g., vibration) at multiple different locations on the machine suggests that the signal has a source that is distant from the current measurement locations, such that the location and the modality and configuration (e.g., sampling frequency, sensing rate, dynamic range, gain, sensitivity, etc.) of one or more sensors is adjusted to a location of the likely source of the signal (e.g., a centroid weighted based on the strength of the measured signals and/or based on the known structure of the machine and components near the centroid that are likely sources of the detected type of signal).

The process continues back to block 201 to continue to capture raw data through the sensors to obtain additional sensor measurements based on the output from block 211. The computations are performed by the edge processor 116 and the ML accelerator 118 in real time, in that adaptations of the sensor configuration (e.g., locations, modalities, and configurations) are computed within seconds, rather than offline or in a batch mode, such that the sensing unit is efficiently adapted to the machine to measure its condition, without requiring a technician or a robot to wait for long periods. In some embodiments, the additional sensor measurements are used, after processing at blocks 202, 203, and 204, to further train the autoencoder models at block 205. In some embodiments, labeling of the captured data (e.g., manual labeling by a human technician as feedback) is used to grade or rank or score (e.g., thumbs up/thumbs down or score from 1 to 5) whether the newly captured data after performing the adaptation or adjustment of the sensors provided additional useful information, and the feedback is used to retrain or adjust the prompt of the LLM (e.g., reinforcement learning, optionally based on human feedback). In addition to retraining the individual, per-machine ML models, the feedback (e.g., grading, ranking, or scoring) can be shared across ML models trained for the same machine family type and/or used to retrain the shared ML model for the machine family type. Once the models are sufficiently trained, the work flow process of FIG. 2 could occur in a more efficient manner. For example, new raw data could be obtained and processed at 201-204 and then jump to 208-211 to analyze the new data to determine if a fault occurred or could be occurring. Alternatively, if no fault is determined at 208 the work flow could jump to 201 to collect more data directly. In various embodiments of the present disclosure, the capturing of additional raw data at 201 is performed at different time intervals. For example, after collecting measurements during one measurement session, the machine may be operated as normal until a next measurement session (e.g., one day or one week later), where the data collected during a prior session may be stored in the historical machine data 207.

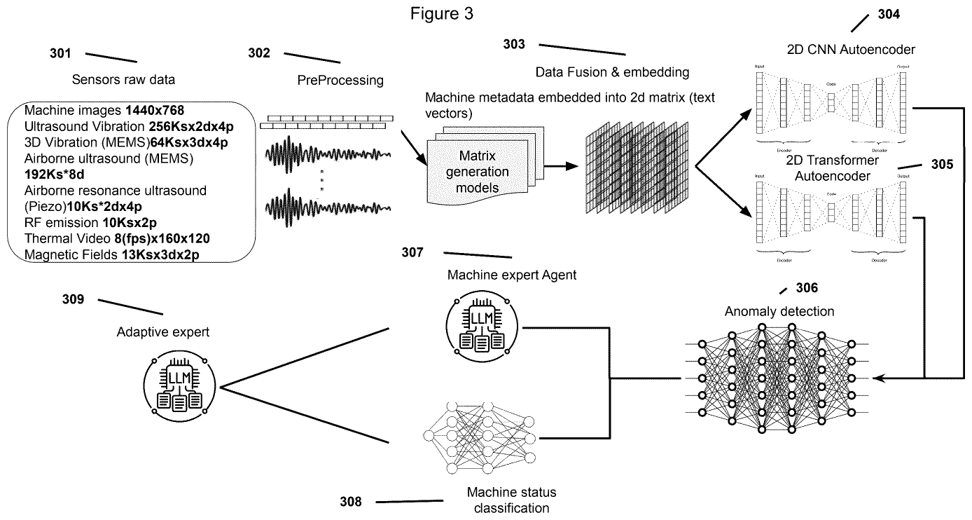

FIG. 3 provides a high-level work flow pictorial version of the flow diagram provided in FIG. 2. At 301, raw sensor data including images of the machine, ultrasound vibration data, MEMS vibration data, airborne ultrasound and resonance ultrasound data, RF emission data, thermal video data, and magnetic field data, for instance, are captured by the system and preprocessed at 302 (e.g., to perform single-modal and multi-modal feature extraction). At 303, data fusion and embedding is performed to embed the machine data into matrices. The matrices are used to train machine learning models such as a 2D CNN autoencoder 304 and a 2D transformer autoencoder 305. The outputs of the autoencoders are supplied to an anomaly detection ML model 306, illustrated in FIG. 3 as a fully connected deep neural network (FCNN), although embodiments of the present disclosure are not limited thereto. The detected anomalies are supplied to a machine expert agent 307 (e.g., a large language model that is fine-tuned or retrained based on information regarding detection and analysis of machine faults and documentation such as schematics of the machine being analyzed) and prompted to classify or determine a source of a problem based on the detected anomalies. In addition, the detected anomalies may be supplied to a machine status classifier ML model 308 to classify the detected anomalies (e.g., no anomaly detected, bearing failure detected, pump clog detected, and the like), which may also be implemented as a fully connected deep neural network, although embodiments of the present disclosure are not limited thereto. The problems detected by the machine expert agent 307 and the classifications of the anomalies generated by the machine status classifier ML model 308 are provided to an adaptive expert ML model 309, which may also be implemented using a large language model. The adaptive expert ML model 309 is similarly trained or fine-tuned based on information regarding detection and analysis of machine faults and documentation regarding the machine being analyzed and generates instructions for adapting (e.g., repositioning, reconfiguring, etc.) the sensors to obtain more detailed information regarding the machine status. In embodiments where the sensor placement is performed manually by a human technician, the adaptive expert ML model 309 is configured to generate natural language instructions to direct the human technician. In embodiments where the sensor placement is performed by a robot, the adaptive expert ML model 309 generates (and executes) an appropriate call to an application programming interface (API) to control the robot to perform the adaptation to the sensors.

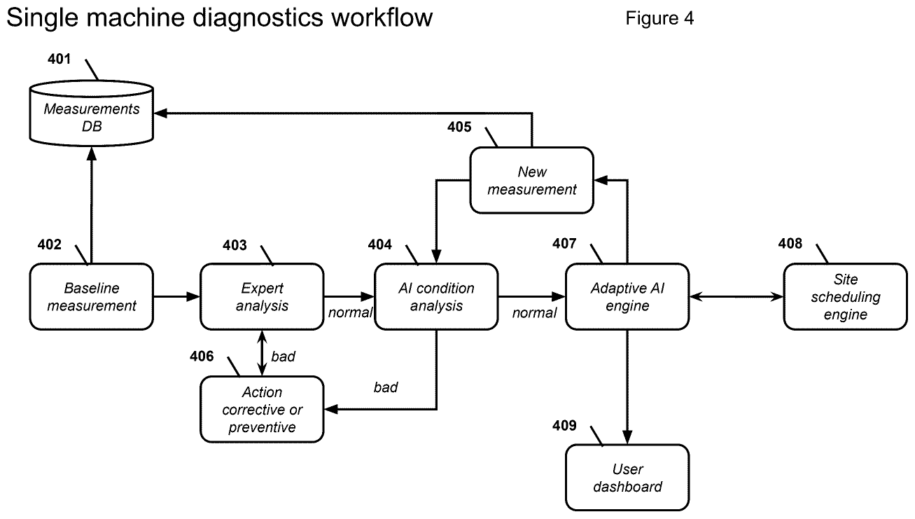

FIG. 4 provides a high-level single machine diagnostic workflow. Measurements captured during diagnostics of a single machine are stored in a measurements database (DB) 401. At 402, a baseline measurement is performed on the machine, where the baseline measurement is performed while the machine is operating under nominal or typical or normal conditions (e.g., no anomalies), although embodiments of the present disclosure are not limited thereto and may also apply to circumstances where the baseline measurement is performed while the machine exhibits with one or more anomalies. In some cases, the measurements are supplied to a subject matter expert (e.g., a human expert such as a trained technician, or an LLM expert agent trained as machine expert as disclosed in 307) for analysis at 403, where the expert may determine whether the machine condition is normal or bad. In a case where the measurements are normal, then the baseline measurement is provided to AI condition analysis 404 to configure a baseline ML model for the given machine. In a case where the expert determined at 403 that the baseline measurements indicate that the machine is in a bad state, then corrective or preventative actions are taken at 406. As new measurements are taken at 405, the measurements are stored in the measurement database 401 and provided for AI condition analysis at 404, which, as discussed above, is trained to determine whether the machine condition is normal (e.g., no change from the normal baseline) or bad (e.g., anomaly detected with respect to the baseline). In a case where the condition is bad, corrective or preventative action is taken at 406 and, if the condition of the machine is good, then the measurements are used by the adaptive AI engine at 407 to collect additional measurements (e.g., adapting the sensors, such as changing locations, sensing modes, and the like). At 408, a site scheduling engine schedules follow-up measurements for the machine (e.g., whether anomalous conditions indicate that parts should be monitored for further degradation). The information regarding the measured status of the machine may also be displayed in a user dashboard 409 (e.g., visible through a web page).

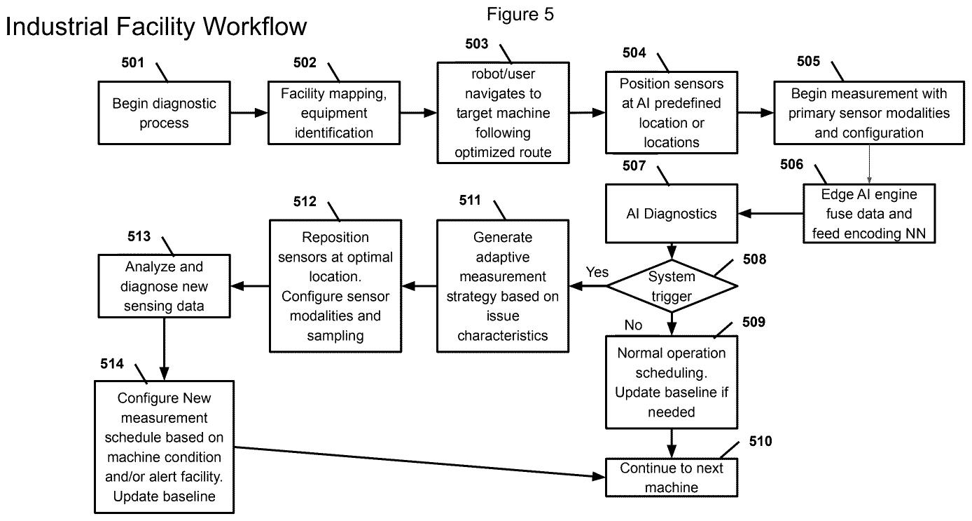

FIG. 5 provides the work flow diagram for providing diagnostics to an entire industrial facility of machines. In this workflow the facility is mapped out and each machine of the facility is investigated by the diagnostic system of FIG. 1. In various embodiments, the sensor unit is moved to different places within the facility by a human or by a robot. At 501, the diagnostic process begins, where, at 502, the facility is mapped and equipment within the facility is identified. In some embodiments, the steps at 502 are performed autonomously, such as where a robot follows a mapping procedure (e.g., simultaneous localization and mapping (SLAM)) to explore reachable areas within the facility and to identify machines within the facility using, for example, asset tags (e.g., barcodes) attached to the machines and/or computer vision to classify machines (e.g., based on images captured by video/image sensors 102). At 503, the robot (or human) navigates to a target machine to be analyzed, where the route may be optimized based on pathfinding techniques. At 504, the sensors of the sensing unit are positioned at a predefined location or predefined locations, where the one or more predefined locations may be determined by a ML model (e.g., based on predictions of locations that are expected to provide the most information regarding whether the machine is exhibiting anomalous behavior). At 505, the sensing unit begins measurements of the target machine based on the primary sensor modalities and configuration, and at 506 the edge computing devices (e.g., digital signal processor, edge processor 116, ML accelerator processor 118, and the like at the edge such as at the sensing unit) fuses the data and performs anomaly detection as described above. At 507, the detected anomalies are provided to perform diagnostics (e.g., by the machine expert agent ML model 307, the machine status classification ML model 308, and the adaptive expert ML model 309) to determine the operating condition of the target machine. At 508, the system determines whether a trigger condition is reached. If not (e.g., condition of the machine is normal), then at 509 normal operation is scheduled (e.g., a next check on the target machine is scheduled) and a baseline ML model of the machine is updated (e.g., retraining of the per-machine ML model for the target machine) based on the new measurements (e.g., to capture drift in behavior of the machine). At 510 the process continues by selecting the next machine of the facility as the target machine and proceeding to navigate to the new target machine at 503, where the next machine may be selected based on a schedule set in accordance with the detected conditions of the machine, as described above at 408 of FIG. 4.

In a case where the trigger condition is met, then at 511 the system (e.g., the adaptive expert ML model 309) generates an adaptive measurement strategy based on characteristics of the detected issue or anomaly, and at 512 generates instructions for the human technician or robot to adapt the sensors, such as repositioning at new (e.g., optimal) locations and configuring sensor modalities, then sampling the sensors to capture new sensing data. At 513, the system analyzes and diagnoses the new sensing data (e.g., performing another iteration starting at 202 of FIG. 2 or returning to 506 of FIG. 5). After completing the measurements on the target machine, a new measurement schedule is set based on machine condition or alert facility (e.g., determining that the machine is at risk of further degradation and therefore monitoring the machine more closely by performing measurements more frequently) and updating the baseline model of the machine, as appropriate (e.g., to capture the degradation in a newly trained ML model for the machine based on the autoencoder). At 510, the process continues by selecting the next machine in the facility to be measured (e.g., based on the schedule that was updated based on the conditions of the machines).

FIG. 6 is a table providing the details of each sensor modality and the information provided in the 2D matrix output of spatial and temporal information. In this exemplary system the matrices 600 are 4×4 (four rows by four columns), but other sizes could be used. For example, the number of rows and number of columns in the matrix may depend on the aspect ratio of the machine (e.g., a machine having similar length, width and height may be analyzed with a square matrix, whereas machines that are longer and thinner may have matrixes that have smaller aspect ratios. The dimensions of the matrices may vary depending on the viewing angle to the machine, based on the cross-sectional profile of the machine. The table in FIG. 6 includes a first column of sensors 601, a second column indicating the types of spatial features 602 extracted from the corresponding sensors, a third column indicating temporal features 603 extracted from the corresponding sensors, and a fourth column indicating how the features for each sensor are represented as an output matrix 604. The example sensors listed in FIG. 6 include vision 605, thermal video 606, ultrasound vibration 607, 3D vibration 608, 3D airborne ultrasound (MEMS) 609, airborne ultrasound (piezo resonance) 610, magnetic fields 611, and RF emission per band 612. This information is fed into the autoencoders of FIG. 3 (304 and 305) to produce the CNN and transformer models used for baseline comparisons to new data samples to assess whether there are anomalistic conditions occurring in the anomaly detector 306.

FIG. 7 provides example matrices for four of the sensors referenced in FIG. 6, column 601 and rows 605, 606, 607 and 608. In FIG. 7, these same sensors are labeled high speed video 701, thermal image 702, ultrasound energy 703 and vibration energy 704. In the example of FIG. 7, Euler magnification is applied to the high speed video 701. In this example, the four sensors produce the 4×4 matrices listed in FIG. 6, column 604, rows 605-608 and identified in FIG. 7 as 706, 707, 708 and 709. The measurements taken for the FIG. 7 matrices 706, 707, 708 and 709 are at a single point in time. Over time, sensor measurements can be taken over multiple locations enabling interpolation to occur over multiple matrices. These matrices 710 are fed through the autoencoder 711 to fuse and encode the data and to train the models.

With respect to the adaptive expert model shown at and discussed with respect to FIG. 1, 118, 119, FIG. 2, 209, 210, FIG. 3, 309, FIG. 4, 407 and FIG. 5, 511, 512, in some embodiments the adaptive measurement strategy provides three degrees of freedom in measurement adaptation:
1. Spatial Adaptation (Where to Measure): The system dynamically determines optimal or improved measurement locations on the machine. This example is based on signal sensitivity (locator when fault signal is higher), signal-to-noise ratio optimization, fault signature propagation paths, historical success rates for similar conditions, and accessibility and safety constraints. For example, detecting a developing bearing fault, the system guides measurement to the load zone where forces concentrate, then to perpendicular locations to distinguish radial from axial loading issues. In another example, when electrical issues are detected the system guides the sensor to the middle of the machine near the rotor and stator core.
2. Temporal Adaptation (When to Measure): The system controls measurement timing in this exemplary example based on machine operational state (startup, steady-state, coast-down), production schedules and load variations, fault development rates from trending analysis, and environmental conditions affecting measurements. The measurement interval or sample rates can vary too, e.g. when to take the next measurement (in 10 minutes, one hour, next day, next week, etc.) For example, for gear mesh problems, measurements synchronize with specific load conditions where tooth contact patterns are most revealing.
3. Modal Adaptation (How to Measure): The system selects and configures sensors in this exemplary example based on suspected fault characteristics, signal frequency content, environmental interference, and required diagnostic confidence. For example, detecting potential electrical issues, the system prioritizes magnetic and RF sensing while increasing temporal sampling rates and duration to capture high or low-frequency transients. Also the system can change sensor configuration to improve issue sensitivity (e.g., increase sampling frequency, measurement duration, gain, etc.).

By fusing data from multiple sensor modalities/locations/machine operational states and guiding the data collection process, the multi-modal model achieves a diagnostic accuracy that has a much higher level of diagnostic resolution compared with statically positioned, limited-modality systems. It can reliably differentiate between faults with similar symptoms, such as distinguishing a stator winding fault from a rotor bar defect in a motor, by correlating subtle signatures (e.g. at a point in time or over time such as days and weeks) across multiple sensing domains, including magnetic, electromagnetic (e.g., RF), visual (visible light), thermal, ultrasound, and vibration domains. This adaptive, elastic approach to data collection ensures that diagnostic conclusions are based on relevant information, transforming predictive maintenance and diagnostics for performance and efficiency into a dynamic, intelligent investigation.

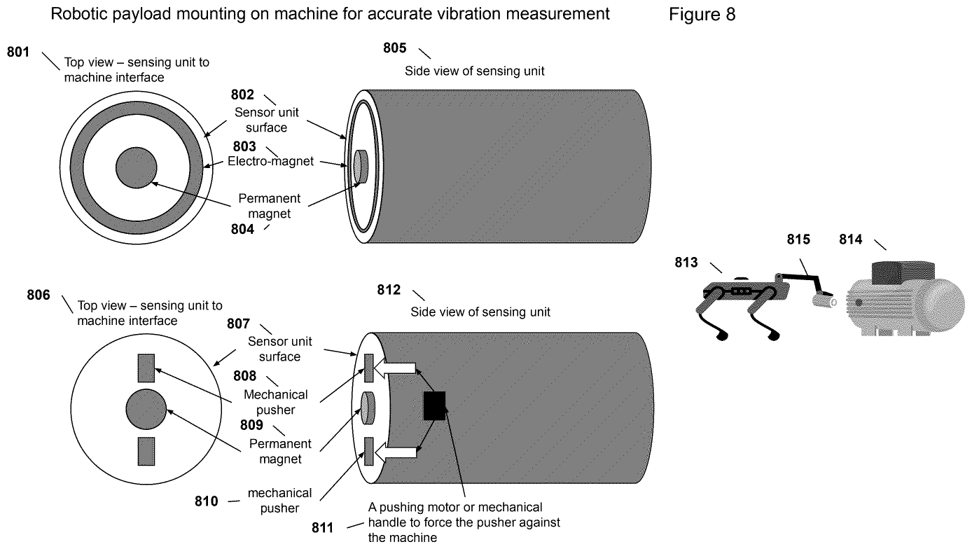

The sensing system can be mounted on a mobile autonomous unit (e.g., a robot) or deployed by a human operator (e.g., a technician). When fully automated, the system uses a robot or mobile autonomous unit such as a humanoid, aerial drone, quadruped (see, e.g., quadruped 813 in FIG. 8), etc. equipped with vision systems for autonomous navigation within complex industrial facilities. It follows optimized routes to move between machines, as determined by a scheduling model that keeps track of the status of the machines on an industrial floor being monitored by the system.

In FIG. 8 an attachment and detachment mechanism allows the robot to securely and precisely place the sensing unit 805 or 812 on a machine 814 for measurement and then retrieve the sensing unit after raw data has been collected. In one example, for contact sensors, this mechanism combines a strong permanent magnet with an electromagnet 803, 804. The robot approaches the target location with the electromagnet 803 activated, which generates an opposing field that neutralizes the permanent magnet 804, preventing premature sticking. Once the robot confirms the positioning of the sensor (e.g., based on computer vision or an accelerometer), the electromagnet 803 is deactivated, allowing the permanent magnet 804 to create a strong bond for e.g., high-fidelity vibration measurements. To retrieve the unit, the electromagnet 803 is reactivated to cancel the magnetic force, allowing the robot to detach the sensor 801, 805 with minimal effort, preventing wear on its joints.

Alternative attachment mechanisms include the permanent magnet 809 and a mechanical pusher system 808, 810 to create a small air gap to reduce the magnetic force, allowing for easy removal by the robotic platform. For example a handle mechanism connected to an actuator 811. When actuated, this handle creates distance between the magnet and the machine surface 806. The handle mechanism can even be a screw rotated by an actuator where the rotation period is so small that only a small force is needed by the motor while enough rotation increases the air gap and reduces the magnetic force by 1/air-gap-distance\hat{ }2 so that the robot can easily navigate or pull the sensing unit 812 from the machine 814.

An additional part of the attachment system is the attachment of the sensing unit to the robotic arm 815 to ensure vibration isolation to prevent contamination of measurements. This system by way of example employs a multi-layer isolation mount consisting of a rigid plastic frame connected to the robotic platform, surrounded by damping elements that effectively absorb and dissipate vibration energy. A secure mechanism, such as, by way of example a ratchet mechanism maintains secure positioning while preserving isolation integrity, ensuring that the robotic platform's movements don't affect sensitive measurements.

Complementing this hardware are operational protocols that further enhance measurement quality. The system automatically shuts down robot fans, motors, and other dynamic components during critical measurement periods, eliminating potential vibration sources. Advanced signal processing algorithms identify and filter any remaining robot-generated vibrations from the measurement data, using precalibrated system data.

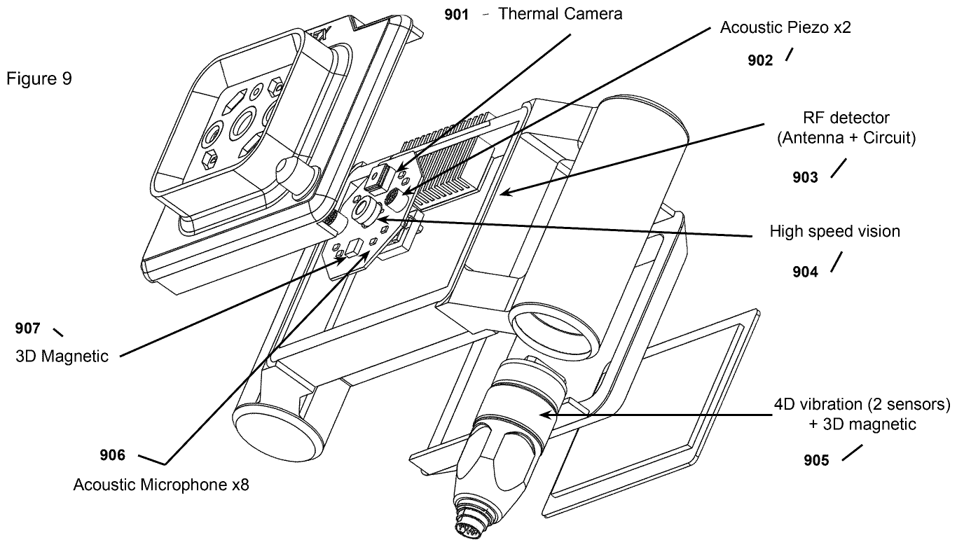

FIG. 9 is an exemplary sensor diagram shown as an exploded view that could be used for contact purposes with reference to FIG. 8 or could be handheld by a human operator who maneuvers the sensor in accordance with the instruction provided by the system in accordance with the discussion earlier see FIG. 1A, 119, FIG. 2, 211, FIG. 3, 309, FIG. 4, 405 or 406 and FIG. 5, 509, 510. In some embodiments, the sensor unit of FIG. 9 includes commercially available sensors such as thermal camera 901, an acoustic Piezo sensor 902, an RF detector 903, a high speed vision camera 904 capable of taking video and single shots, a multi-modal vibration and 3D magnetic unit 905 (e.g., including a 3D magnetic sensor, vibration sensors both piezo and MEMS), an acoustic microphone 906, and a 3D magnetic sensor 907.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

The term non-transitory computer-readable medium is to be understood herein to refer to one or more non-transitory computer-readable media, such as a single solid-state drive, multiple solid-state drives connected in a redundant array of independent drives, one or more hard disk drives (e.g., magnetic data storage media), one or more optical (e.g., CD-ROM or DVD-ROM) media, one or more pools of data storage devices connected to one or more computer servers, and the like.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner.

According to one embodiment of the present disclosure, an n apparatus for providing locations for sensors monitoring a condition of a machine within an industrial setting includes: a plurality of sensors having a plurality of sensor modalities for monitoring one or more conditions of the machine, each sensor obtaining spatial and temporal data along with metadata for identifying the machine, a first processor, a second processor including a machine learning (ML) accelerator, and a non-volatile memory storing: a first model trained to identify machine anomalies in a condition of the machine compared with a baseline-condition history of the machine, a second model stored in non-volatile memory with images and internal structures of the machine, first instructions that, when executed by the first processor, cause the first processor to align the spatial and temporal data obtained from the plurality of sensors and fuse the data into matrix data representative of the condition of the machine, and second instructions that, when executed by the second processor, cause the second processor to: identify one or more machine anomalies by supplying the matrix data to the first model compared to the baseline condition history of the machine, determine one or more characteristics of the one or more anomalies, and identify one or more locations for positioning of one or more of the plurality of sensors to conduct further monitoring of the machine based on supplying the one or more anomalies to the second model.

The monitoring may further include detecting, diagnosing, ruling out, or remediating the machine anomalies.

The second instructions may further include instructions that, when executed, cause the second processor to select which of the plurality sensors to use at one or more locations of the machine to detect machine anomalies.

One or more of the plurality of sensors may include one or more types of sensors selected from the group including: an accelerometer for vibration detection, a magnetic field sensor for magnetic field detection, an electromagnetic emission detector, an acoustic sensor for sound detection, an infrared sensor for thermal detection, and a vision sensor for video or image analysis.

The second processor may determine the positioning locations and operational characteristics of the sensors in real time.

The second processor may determine the operational characteristics including sample frequency, sample duration, or sample rates.

The apparatus may further include an autonomous mobile platform for transporting and positioning the plurality of sensors.

The autonomous mobile platform may include a quadruped robot, a wheeled robot, a humanoid robot or an aerial robot.

The second processor may be an edge processor located on the autonomous mobile platform.

The second processor may obtain feedback from the one or more sensors and in real time positioning the one or more sensors to one or more locations of the machine.

The second processor may further detect, diagnose, rule out, or remediate the machine anomalies.

The one or more sensors may be contact sensors or contactless sensors.

The autonomous mobile platform may include a robotic arm to position the one or more sensors.

The non-volatile memory may further store instructions that, when executed by the first processor, cause the first processor to extract one or more multi-modal features from the spatial and temporal data, a multi-modal feature of the one or more multi-modal features being computed from spatial and temporal data obtained by at least two different sensor modalities among the plurality of sensor modalities.

According to one embodiment of the present disclosure, a method for providing positioning a plurality of sensors monitoring a condition of a machine within an industrial setting, the plurality of sensors having a plurality of sensor modalities for monitoring one or more conditions of the machine, each sensor obtaining spatial and temporal data with metadata for identifying the machine, includes: processing the spatial and temporal data to align matrix data and fuse the data into encoded data representative of the condition of the machine, training a first model stored in non-volatile memory with data to identify machine anomalies in the condition of the machine compared with a baseline-condition history of the machine, prompting the first model to detect machine anomalies in the matrix data compared to the baseline-condition history of the machine and to determine characteristics of the machine anomalies, training a second model stored in non-volatile memory with images and internal structures of the machine, and prompting the second model to automatically position one or more of the plurality of sensors to one or more locations of the machine to conduct further monitoring of the machine.

The step of positioning the sensors may further include detecting, diagnosing, ruling out, or remediating the machine anomalies.

The step of positioning may further include providing natural language instructions for an operator to use or for an autonomous mobile unit to carry out.

The step of positioning may further include choosing which of the plurality sensors to use at one or more locations of the machine to detect, diagnose, rule out or remediate the machine anomalies.

The step of positioning may further include determining the sensor positioning locations and operational characteristics of the plurality of sensors in real time.

The step of determining the operational characteristics of the sensor may further include setting a sample frequency, sample duration, or sample rates of the sensor.

The method may further include the step of transporting and positioning the plurality of sensors with an autonomous mobile platform.

The autonomous mobile platform may include a quadruped robot, a wheeled robot, a humanoid robot or an aerial robot.

The step of positioning the sensors may further include obtaining feedback from the one or more sensors and real-time positioning the one or more sensors to the one or more locations of the machine.

The step of positioning may further include detecting, diagnosing, ruling out, or remediating the machine anomalies.

The one or more sensors may include contact sensors and contactless sensors.

The step of positioning the one or more sensors may further include positioning the one or more sensors with a robotic arm of the autonomous mobile platform.

The method may further include extracting one or more multi-modal features from the spatial and temporal data, a multi-modal feature of the one or more multi-modal features being computed from spatial and temporal data obtained by at least two different sensor modalities among the plurality of sensor modalities.

According to one embodiment of the present disclosure, a diagnostic system includes a plurality of sensors having a plurality of sensor modalities for monitoring a plurality of conditions of a machine, each sensor obtaining spatial and temporal data along with metadata for identifying the machine, a first processor to align the spatial and temporal data obtained from the plurality of sensors into matrix data and fuse the data into encoded data representative of a condition of the machine, a model stored in non-volatile memory with the encoded data to represent a baseline-condition history of the machine, and a second processor including a machine learning accelerator using the model to detect machine anomalies in the encoded data compared to the baseline-condition history of the machine and to position one or more of the plurality of sensors to one or more locations of the machine to conduct further monitoring of the machine.

One or more of the plurality of sensors includes an accelerometer for vibration detection, a magnetic field sensor for electromagnetic detection, an acoustic sensor for sound detection, an infrared sensor for temperature detection or a vision sensor for video or image analysis.

The second processor may determine the positioning and operational characteristics of one or more of the sensors in real time.

The second processor may determine the operational characteristics including sample frequency, sample duration, or sample rates.

The diagnostic system may further an autonomous mobile platform for transporting and positioning the plurality of sensors.

The autonomous mobile platform may include a quadruped robot, a wheeled robot, a humanoid robot or an aerial robot.

The second processor may be an edge processor located on the autonomous mobile platform.

The second processor may obtain feedback from the one or more sensors and in real time positioning the one or more sensors to one or more locations of the machine.

The second processor may further detect, diagnoses, rules out, or remediates the machine anomalies.

The one or more sensors may be contact sensors or contactless sensors.

The autonomous mobile platform may include a robotic arm to position the one or more sensors.

The first processor may be further configured to extract one or more multi-modal features from the spatial and temporal data, a multi-modal feature of the one or more multi-modal features being computed from spatial and temporal data obtained by at least two different sensor modalities among the plurality of sensor modalities.

According to one embodiment of the present disclosure, a method for monitoring a condition of a machine within an industrial setting with a plurality of sensors having a plurality of sensor modalities for monitoring one or more conditions of the machine, each sensor obtaining spatial and temporal data with metadata for identifying the machine includes: processing the spatial and temporal data to align matrix data and fuse the data into neural-net encoded data representative of the condition of the machine, training a first model stored in non-volatile memory to identify a baseline-condition history of the machine, prompting the first model to detect machine anomalies in the encoded data compared to the baseline-condition history of the machine, and positioning one or more of the plurality of sensors to one or more locations of the machine to conduct further monitoring of the machine based on the detected machine anomalies.

The method may further include the step of training a second model stored in non-volatile memory with images and internal structures of the machine, and prompting the second model for positioning of one or more of the plurality of sensors to one or more locations of the machine to conduct further monitoring of the machine.

The step of positioning the sensors may further include detecting, diagnosing, ruling out, or remediating the machine anomalies.

The method may further include providing natural language instructions for an operator to use or for an autonomous mobile unit to carry out.

The step of positioning the sensors may further include choosing which of the plurality sensors to use at one or more locations of the machine to detect, diagnose, rule out or remediate the machine anomalies.

The step of positioning the sensors may further include determining the sensor positioning locations and operational characteristics of the plurality of sensors in real time.

The step of determining the operational characteristics of the sensor may further include setting a sample frequency, sample duration, or sample rates of the sensor.

The method may further include the step of transporting and positioning the plurality of sensors with an autonomous mobile platform.

The method may further include extracting one or more multi-modal features from the spatial and temporal data, a multi-modal feature of the one or more multi-modal features being computed from spatial and temporal data obtained by at least two different sensor modalities among the plurality of sensor modalities.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An apparatus for providing locations for sensors monitoring a condition of a machine within an industrial setting comprising:
a plurality of sensors having a plurality of sensor modalities for monitoring one or more conditions of the machine, each sensor obtaining spatial and temporal data along with metadata for identifying the machine,
a first processor,
a second processor comprising a machine learning (ML) accelerator, and
a non-volatile memory storing:
a first model trained to identify machine anomalies in a condition of the machine compared with a baseline-condition history of the machine,
a second model stored in non-volatile memory with images and internal structures of the machine,
first instructions that, when executed by the first processor, cause the first processor to align the spatial and temporal data obtained from the plurality of sensors and fuse the data into matrix data representative of the condition of the machine, and
second instructions that, when executed by the second processor, cause the second processor to:
identify one or more machine anomalies by supplying the matrix data to the first model compared to the baseline condition history of the machine,
determine one or more characteristics of the one or more anomalies, and
identify one or more locations for positioning of one or more of the plurality of sensors to conduct further monitoring of the machine based on supplying the one or more anomalies to the second model.

2. The apparatus of claim 1 wherein the further comprises detecting, diagnosing, ruling out, or remediating the machine anomalies.

3. The apparatus of claim 2 wherein the second instructions further comprise instructions that, when executed, cause the second processor to select which of the plurality sensors to use at one or more locations of the machine to detect machine anomalies.

4. The apparatus of claim 3 wherein one or more of the plurality of sensors comprises one or more types of sensors selected from the group comprising: an accelerometer for vibration detection, a magnetic field sensor for magnetic field detection, an electromagnetic emission detector, an acoustic sensor for sound detection, an infrared sensor for thermal detection, and a vision sensor for video or image analysis.

5. The apparatus of claim 4 wherein the second processor determines the positioning locations and operational characteristics of the sensors in real time.

6. The apparatus of claim 5 wherein the second processor determines the operational characteristics comprising sample frequency, sample duration, or sample rates.

7. The apparatus of claim 1 further comprises an autonomous mobile platform for transporting and positioning the plurality of sensors.

8. The apparatus of claim 7 wherein the autonomous mobile platform comprises a quadruped robot, a wheeled robot, a humanoid robot or an aerial robot.

9. The apparatus of claim 8 wherein the second processor is an edge processor located on the autonomous mobile platform.

10. The apparatus of claim 9 wherein the second processor obtains feedback from the one or more sensors and in real time positioning the one or more sensors to one or more locations of the machine.

11. The apparatus of claim 10 wherein the second processor further detects, diagnoses, rules out, or remediates the machine anomalies.

12. The apparatus of claim 11 wherein the one or more sensors are contact sensors or non-contact sensors.

13. The apparatus of claim 12 wherein the autonomous mobile platform comprises a robotic arm to position the one or more sensors.

14. The apparatus of claim 1, wherein the non-volatile memory further stores instructions that, when executed by the first processor, cause the first processor to extract one or more multi-modal features from the spatial and temporal data, a multi-modal feature of the one or more multi-modal features being computed from spatial and temporal data obtained by at least two different sensor modalities among the plurality of sensor modalities.

15. A method for providing positioning a plurality of sensors monitoring a condition of a machine within an industrial setting, the plurality of sensors having a plurality of sensor modalities for monitoring one or more conditions of the machine, each sensor obtaining spatial and temporal data with metadata for identifying the machine, comprising:
processing the spatial and temporal data to align matrix data and fuse the data into encoded data representative of the condition of the machine,
training a first model stored in non-volatile memory with data to identify machine anomalies in the condition of the machine compared with a baseline-condition history of the machine,
prompting the first model to detect machine anomalies in the matrix data compared to the baseline-condition history of the machine and to determine characteristics of the machine anomalies,
training a second model stored in non-volatile memory with images and internal structures of the machine, and
prompting the second model to automatically position one or more of the plurality of sensors to one or more locations of the machine to conduct further monitoring of the machine.

16. The method of claim 15 wherein the step of positioning the sensors further comprises detecting, diagnosing, ruling out, or remediating the machine anomalies.

17. The method of claim 16 wherein the step of positioning further comprises providing natural language instructions for an operator to use or for an autonomous mobile unit to carry out.

18. The method of claim 16 wherein the step of positioning further comprises choosing which of the plurality sensors to use at one or more locations of the machine to detect, diagnose, rule out or remediate the machine anomalies.

19. The method of claim 15 wherein the step of positioning further comprises determining the sensor positioning locations and operational characteristics of the plurality of sensors in real time.

20. The method of claim 19 wherein the step of determining the operational characteristics of the sensor further comprises setting a sample frequency, sample duration, or sample rates of the sensor.

21. The method of claim 15 further comprises the step of transporting and positioning the plurality of sensors with an autonomous mobile platform.

22. The method of claim 21, wherein the autonomous mobile platform comprises a quadruped robot, a wheeled robot, a humanoid robot or an aerial robot.

23. The method of claim 22 wherein the step of positioning the sensors further comprises obtaining feedback from the one or more sensors and real-time positioning the one or more sensors to the one or more locations of the machine.

24. The method of claim 23 wherein the step of positioning further comprises detecting, diagnosing, ruling out, or remediating the machine anomalies.

25. The method of claim 24 wherein the one or more sensors comprise contact sensors and contactless sensors.

26. The method of claim 25 wherein the step of positioning the one or more sensors further comprises positioning the one or more sensors with a robotic arm of the autonomous mobile platform.

27. The method of claim 15, further comprising extracting one or more multi-modal features from the spatial and temporal data, a multi-modal feature of the one or more multi-modal features being computed from spatial and temporal data obtained by at least two different sensor modalities among the plurality of sensor modalities.

28. A diagnostic system comprising a plurality of sensors having a plurality of sensor modalities for monitoring a plurality of conditions of a machine, each sensor obtaining spatial and temporal data along with metadata for identifying the machine,
a first processor to align the spatial and temporal data obtained from the plurality of sensors into matrix data and fuse the data into encoded data representative of a condition of the machine,
a model stored in non-volatile memory with the encoded data to represent a baseline-condition history of the machine, and
a second processor comprising a machine learning accelerator using the model to detect machine anomalies in the encoded data compared to the baseline-condition history of the machine and to position one or more of the plurality of sensors to one or more locations of the machine to conduct further monitoring of the machine.

29. The diagnostic system of claim 28 wherein one or more of the plurality of sensors comprises an accelerometer for vibration detection, a magnetic field sensor for electromagnetic detection, an acoustic sensor for sound detection, an infrared sensor for temperature detection or a vision sensor for video or image analysis.

30. The diagnostic system of claim 29 wherein the second processor determines the positioning and operational characteristics of one or more of the sensors in real time.

31. The diagnostic system of claim 30 wherein the second processor determines the operational characteristics comprising sample frequency, sample duration, or sample rates.

32. The diagnostic system of claim 28 further comprises an autonomous mobile platform for transporting and positioning the plurality of sensors.

33. The diagnostic system of claim 32 wherein the autonomous mobile platform comprises a quadruped robot, a wheeled robot, a humanoid robot or an aerial robot.

34. The diagnostic system of claim 33 wherein the second processor is an edge processor located on the autonomous mobile platform.

35. The diagnostic system of claim 34 wherein the second processor obtains feedback from the one or more sensors and in real time positioning the one or more sensors to one or more locations of the machine.

36. The diagnostic system of claim 35 wherein the second processor further detects, diagnoses, rules out, or remediates the machine anomalies.

37. The diagnostic system of claim 36 wherein the one or more sensors are contact sensors or contactless sensors.

38. The diagnostic system of claim 37 wherein the autonomous mobile platform comprises a robotic arm to position the one or more sensors.

39. The diagnostic system of claim 28, wherein first processor is further to extract one or more multi-modal features from the spatial and temporal data, a multi-modal feature of the one or more multi-modal features being computed from spatial and temporal data obtained by at least two different sensor modalities among the plurality of sensor modalities.

40. A method for monitoring a condition of a machine within an industrial setting with a plurality of sensors having a plurality of sensor modalities for monitoring one or more conditions of the machine, each sensor obtaining spatial and temporal data with metadata for identifying the machine, the method comprising:
processing the spatial and temporal data to align matrix data and fuse the data into neural-net encoded data representative of the condition of the machine,
training a first model stored in non-volatile memory to identify a baseline-condition history of the machine,
prompting the first model to detect machine anomalies in the encoded data compared to the baseline-condition history of the machine, and
positioning one or more of the plurality of sensors to one or more locations of the machine to conduct further monitoring of the machine based on the detected machine anomalies.

41. The method of claim 40 further comprising the step of training a second model stored in non-volatile memory with images and internal structures of the machine, and prompting the second model for positioning of one or more of the plurality of sensors to one or more locations of the machine to conduct further monitoring of the machine.

42. The method of claim 41 wherein the step of positioning the sensors further comprises detecting, diagnosing, ruling out, or remediating the machine anomalies.

43. The method of claim 42 further comprises providing natural language instructions for an operator to use or for an autonomous mobile unit to carry out.

44. The method of claim 42 wherein the step of positioning the sensors further comprises choosing which of the plurality sensors to use at one or more locations of the machine to detect, diagnose, rule out or remediate the machine anomalies.

45. The method of claim 41 wherein the step of positioning the sensors further comprises determining the sensor positioning locations and operational characteristics of the plurality of sensors in real time.

46. The method of claim 45 wherein the step of determining the operational characteristics of the sensor further comprises setting a sample frequency, sample duration, or sample rates of the sensor.

47. The method of claim 40 further comprises the step of transporting and positioning the plurality of sensors with an autonomous mobile platform.

48. The method of claim 40, further comprising extracting one or more multi-modal features from the spatial and temporal data, a multi-modal feature of the one or more multi-modal features being computed from spatial and temporal data obtained by at least two different sensor modalities among the plurality of sensor modalities.
